(19) United States
(12) Patent Application Publication
(10) Pub. No.: US 2013/0174419 A1
(43) Pub. Date: Jul. 11, 2013

(54) METHOD FOR PRODUCING A PISTON RING

(71) Applicant: Klaus Meyer, Wermelskirchen (DE)

(72) Inventor: Klaus Meyer, Wermelskirchen (DE)

(73) Assignee: FEDERAL-MOGUL BURSCHEID GMBH, Burscheid (DE)

(21) Appl. No.: 13/822,923

(22) PCT Filed: Jun. 29, 2011
(86) PCT No.: PCT/DE2011/001384

§ 371 Date: Mar. 13, 2013

(30) Foreign Application Priority Data
Sep. 27, 2010 (DE) 10 2010 46 551.8

(51) Int. Cl. B23P 15/06

(52) U.S. Cl. CPC B23P 15/06
USPC 29/888.074

(57) ABSTRACT

Method for producing a piston ring provided with a butt joint, in that an annular metallic main body is provided with at least one hard layer at least in the area of the outer circumferential surface of said main body, wherein after this coating the inner circumferential surface of the piston ring is at least partially subjected to a wall-thickness-reducing material removal process.

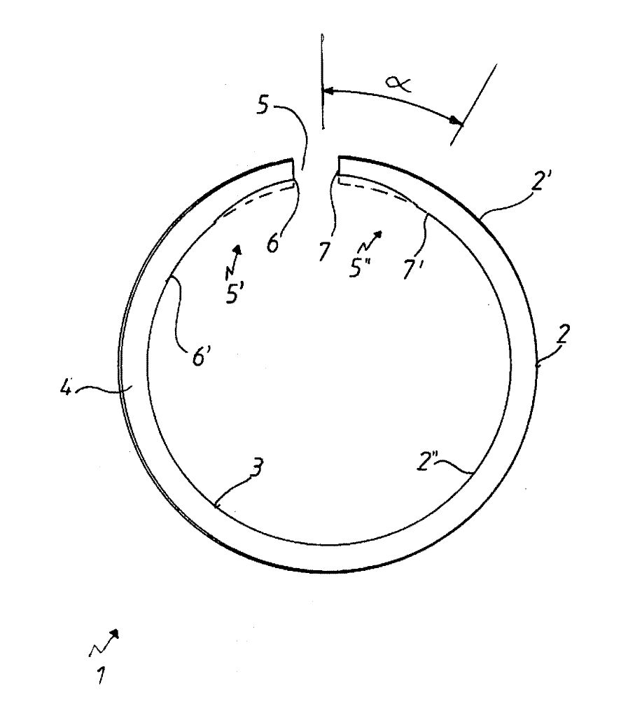

### BACKGROUND OF THE INVENTION

The invention relates to a method for producing a piston ring provided with a butt joint.

Due to increasing power density in both gasoline engines and diesel engines, the load on the piston ring, with regard to wear- and temperature-resistance, increases to the same extent. In order to counteract this, piston rings, which are chromed or nitrided on the running surface and which already entail a high degree of hardness, are being frequently produced. Piston rings that include very hard layer systems, such as PVD (Physical Vapor Deposition) or HVOF (High Velocity Oxygen Fuel) layers, for example, are also being used, again with regard to the aforementioned power density. This degree of hardness brings high internal stresses, which may affect the ring shape and the radial pressure distribution.

Both during manufacture and when used in an engine, these high internal stresses generate an undesired change in the ring shape and radial pressure distribution. In particular, the so-called bimetallic effect occurs due to a thermal expansion that is substantially lower than the piston ring base material, and this means that at the existing operating temperatures an increased pressure occurs in the area of the butt joint. This in turn leads to increased wear on the running surface, particularly in this area.

One possible countermeasure would be an adapted design of the piston ring geometry (negative ovality), which in the extreme case might lower the radial pressure in the butt joint area to such an extent that a gap forms. However, particularly in connection with compression piston rings made from profiled wire, this method is not workable from a manufacturing point of view. A sufficient radial pressure in the butt joint is critical for the machining result, especially when machining the running surface by way of cylindrical lapping.

Due to the butt joint play and butt joint play tolerances becoming ever narrower, the technical efficacy of generating negative ovalities in order to counter the high internal stresses cannot be economically implemented since the lapping bushing already must be replaced after a very short period of time.

DE 100631 discloses a method of achieving a uniform contact pressure on all sides on the sealing surface in the case of sealing rings of a constant cross-section, wherein the ring is compressed by hammering or rolling on the outer or inner surface, depending on whether the ring is intended to spring inward or outward, and specifically is compressed to the greatest extent at the point opposite the ends thereof and from there gradually less so toward the ends.

DE 36 12 454 A1 discloses a piston ring for gas sealing, wherein the ring tapers from the inner radius toward the butt joint ends in a manner so that in the event of lifting of the butt joint ends due to the inertial force, no twisted torque or only a reduced twisted torque can arise at the lifting point, and the butt joint design thereof widens toward the top so that the ring is not very gas-tight toward the top land.

### SUMMARY OF THE INVENTION

The problem addressed by the invention is that of providing an economical method for producing a piston ring provided with a hard coating in the area of the running surface, which is suitable for the ever-increasing power densities in both petrol engines and diesel engines.

This problem is solved by a method for producing a piston ring provided with a butt joint, in that an annular metallic main body is provided with at least one hard layer at least in the area of the outer circumferential surface of the main body, wherein after this coating the inner circumferential surface of the piston ring is at least partially subjected to a wall-thickness-reducing material removal process, and the material removal, starting from the butt joint, takes place over 10 to 120°, preferably 90°, of the circumference of the main body, in each circumferential direction starting from the butt joint, and wherein at least the inner circumferential surface of the main body is provided with a nitriding layer that, after the coating of the outer circumferential surface of the main body, is subjected to the material removal.

It is of particular advantage that the machining of the inner circumferential surface, in particular in the butt joint area, is carried out after the final cylindrical lapping process. In this case, the machining may take place from the butt joint ends over at most 120°, preferably 90°, in both circumferential directions, starting from the butt joint.

The invention relates exclusively to piston rings, in particular compression piston rings, which are provided with extremely hard running surface coatings (for example PVD or HVOF) that cause the problems mentioned in discussing the background of the invention.

Due to the material removal, particularly in the circumferential area close to the butt joint, the radial geometrical moment of inertia is reduced. The reduction in the geometrical moment of inertia, particularly in the areas close to the butt joint, leads to a targeted reduction in the radial pressure.

At the same time, at the operating temperature of the piston ring, the change in shape brought about by the bimetallic effect is additionally reduced, since the proportion of faster-growing material having greater thermal expansion, namely, the base material, is smaller.

It is of particular advantage that, in the case of piston rings nitrided on the inner circumferential surface, this effect is additionally amplified since the nitriding layer has internal compressive stresses. When such stresses are removed due to a partial removal of the nitriding layer, the radial pressure on the running surface is likewise reduced.

Due to the possibility of being able to bring about the reduced radial butt joint pressure at the end of the machining process, the piston ring can be designed for the production process with a higher butt joint pressure (for example, circular or positive-oval). In particular, this has a positive effect on the lapping process, which is critical for the tribological behavior of the running surface.

In addition to the aforementioned reduced wear on the running surface at the butt joint, a reduction in wear on a friction partner, for example a cylinder liner, is also brought about as a result of better tribological properties of the running surface coating of the piston ring.

Furthermore, an improved lapping result can be produced on piston rings with a low tangential force.

The subject matter of the invention is shown in the drawing on the basis of an example of embodiment and will be described as follows.

### BRIEF DESCRIPTION OF THE DRAWING

The single FIGURE schematically shows a piston ring according to the invention.

### DETAILED DESCRIPTION OF THE INVENTION

The piston ring 1, in particular a compression piston ring, shown in the drawing has a running surface 2, an inner circumferential surface 3, and an upper ring flank 4. The piston ring 1 additionally has a butt joint 5. In this example, the piston ring 1 is to be provided with a PVD layer 2′ applied onto the running surface 2. As already mentioned, such hard running surface layers affect the internal stress of the piston ring 1, and do so particularly in terms of the fact that the (softer) base material of the piston ring 1 and the (harder) PVD have different thermal expansions that have a negative effect on the butt joint area 5 in particular. This means that the butt joint area 5 springs radially outward, and therefore, generates in this area an increased contact pressure force on the friction partner, for example, a cylinder liner. In order to counteract this negative effect, it is proposed, according to the invention, after the surface coating of the piston ring, in particular the coating of the running surface 2 with a PVD layer 2′ and a lapping process, to subject the problematic areas of the piston ring 1, namely the areas 5′, 5″ close to the butt joint on the piston ring 1, to a machining process such that, starting from the butt joint edges 6, 7 of the butt joint 5, a material removal is brought about over a circumferential angle α of 20°, for example. In this case, the material removal is at maximum in the area of the respective butt joint edges 6, 7 and decreases in the direction of the run-out 6′, 7′. Depending on the ring design and the application, the angle α may be up to 90°.

This measure counters the so-called bimetallic effect caused by different material pairings, which is brought about by coating a softer main body with a harder material.

In some cases, it is necessary to nitride piston rings, wherein a hard surface layer is already produced by the nitriding process. If a PVD or HVOF layer is then deposited on this nitriding layer, the nitriding layer on the inner circumference of the piston ring must also be at least partially reduced by material removal or completely removed, at least over part of the inner circumference, in order to reduce the high internal stress that then exists.

1.-6. (canceled)

7. A method for producing a piston ring, comprising:
forming a piston ring comprised of an annular main metallic body of uniform wall thickness, having a butt joint and inner and outer circumferential surfaces, wherein wall thickness is defined as distance between the inner and outer circumferential surfaces;
providing, at least on the outer circumferential surface of the main body, at least one layer of a hard material;
providing at least the inner circumferential surface of the main body with a nitriding layer; and
reducing the wall thickness of circumferential portions of the main body by removing material, including nitriding layer material, from corresponding circumferential portions of the inner circumferential surface, the circumferential portions of the inner circumferential surface from which the material, including the nitriding layer material, is removed being 10 to 120° starting at the butt joint in each circumferential direction.

8. The method of claim 7, further comprising, prior to the removing material from the inner circumferential surface, subjecting the coated outer circumferential surface to a lapping process.

9. The method of claim 9, wherein the reducing of the wall thickness by the removal of the material from the inner circumferential surface of the main body is only at said 10 to 120° circumferential portions of the inner circumferential surface.

10. The method of claim 7, wherein the circumferential portions of the inner circumferential surface of the main body subjected to the material removal are 90° in each circumferential direction starting at the butt joint.

11. The method of claim 7, wherein amount of the material removal and the wall thickness reduction decreases in each circumferential direction away from the butt joint.
